(19) United States
(12) Patent Application Publication
(10) Pub. No.: US 2003/0009644 A1
(43) Pub. Date: Jan. 9, 2003

(54) Bi-directional RAM for data transfer using two clock frequencies having no multiple relation

(75) Inventor: Michiya Fujii, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/188,193

(22) Filed: Jul. 1, 2002

(30) Foreign Application Priority Data
Jul. 5, 2001 (JP) 2001-204910

(51) Int. Cl. G06F 12/00

(52) U.S. Cl. 711/156; 711/167

(57) ABSTRACT

A bi-directional RAM is coupled between a first control device for data transfer using a first clock frequency and a second control device for data transfer using a second clock frequency having no multiple relation with the first clock frequency. The bi-directional RAM includes first and second data registers, first and second flag registers, and first and second controllers. The first controller performs a data input to the first data register and a data output from the second data register using the first clock frequency, and sets a flag in the first flag register when data is input to the first data register. The second controller performs a data input to the second data register and a data output from the first data register using the second clock frequency, and sets a flag in the second flag register when data is input to the second data register.

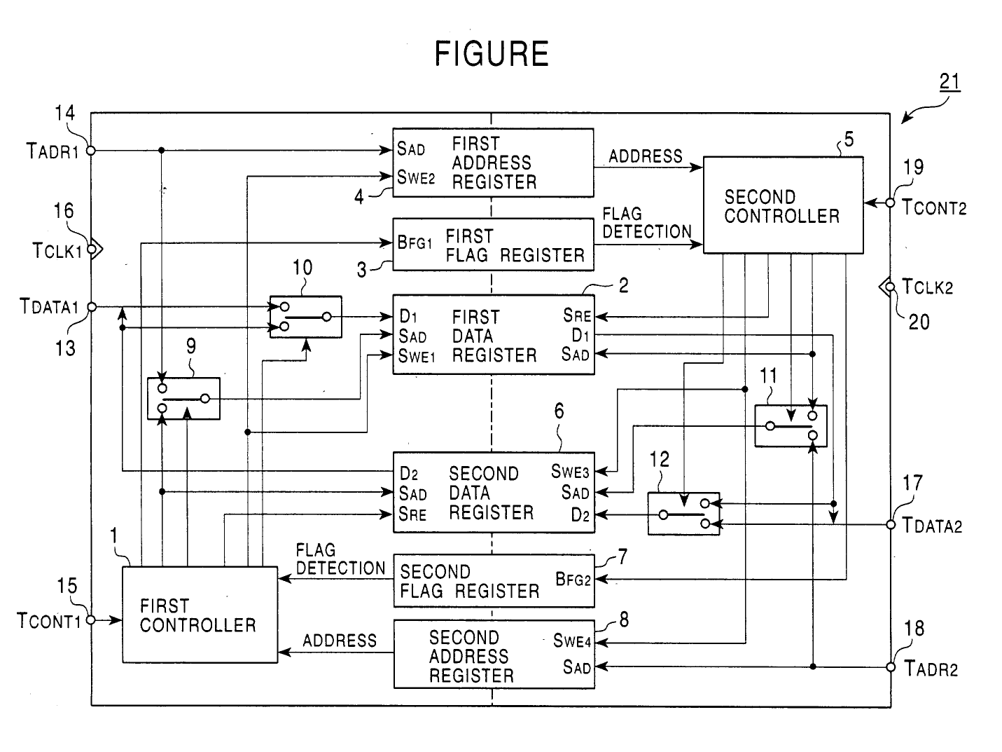

### BACKGROUND OF THE INVENTION

1. Field of the Invention

The present invention relates to a bi-directional RAM, and more particularly to a bi-directional RAM coupled between a first control device for data transfer using a first clock frequency and a second control device for data transfer using a second clock frequency different from the first clock frequency.

2. Description of the Related Art

In general, an interface such as a PCI (peripheral component interconnect) or a PC card is used to couple a first control device such as a personal computer to a second control device such as a wireless local area network (LAN). If a control unit or a central processing unit (CPU) incorporated in the second control device does not support such an interface, an integrated circuit (IC) having an internal RAM is required to compensate the difference in signal control format between the first control device and the second control device. When data is supplied from the first control device to such an integrated circuit having an internal RAM (hereinafter referred to simply as “integrated circuit”), the integrated circuit buffers the data in the RAM, and then reads the data, buffered in the RAM to supply it to the second control device. When data is supplied from the second control device to the integrated circuit, the integrated circuit buffers the data in the RAM, and reads the data buffered in the RAM to supply it to the first control device.

Typically, the integrated circuit is configured so that a clock frequency used for data transfer in the first control device is the same as a clock frequency used for data transfer in the second control device or one of the clock frequencies is an integer multiple or an integer fraction of the other clock frequency, and selects a clock frequency for activation of the integrated circuit so as to be the same as the clock frequencies used in the first and second control devices or to be an integer multiple or an integer fraction of either clock frequency. In this way, the clock frequency for the integrated circuit is selected so as to be the same as the clock frequencies for the first and second control devices or to be an integer multiple or an integer fraction of either clock frequency, thus relatively facilitating a data input to the RAM in the integrated circuit and a data output from the RAM. This simplifies the overall structure of the integrated circuit, in particular, a portion associated with the RAM.

However, when a clock frequency used for data transfer in the first control device is different from a clock frequency used for data transfer in the second control device, and when one of the clock frequencies is not an integer multiple or an integer fraction of the other clock frequency, a data input to the RAM and a data output from the RAM are not facilitated even if the clock frequency for activation of the integrated circuit is selected so as to be the same as either clock frequency or to be an integer multiple or an integer fraction of either clock frequency. As a result, circuits, such as a buffer circuit and a control circuit associated therewith, for compensating the difference between the clock frequencies are required. In addition, some limitation is imposed on a data input to the RAM and/or a data output from the RAM, thus making complex the overall structure of the integrated circuit, in particular, a portion associated with the RAM, leading to increased production cost.

### SUMMARY OF THE INVENTION

The present invention has been made in view of such a technical background, and has an object to provide a bi-directional RAM capable of a data input and data output using two clock frequencies having no multiple relation to simplify the structure.

To this end, the present invention provides a bi-directional RAM coupled between a first control device for data transfer using a first clock frequency and a second control device for data transfer using a second clock frequency having no multiple relation with the first clock frequency. The bi-directional RAM includes a first data register, a second data register, a first flag register, a second flag register, a first controller, and a second controller. The first controller performs a data input to the first data register and a data output from the second data register using the first clock frequency, and sets a flag in the first flag register when data is input to the first data register. The second controller performs a data input to the second data register and a data output from the first data register using the second clock frequency, and sets a flag in the second flag register when data is input to the second data register.

Accordingly, a data input to the first data register and a data output-from the second data register are performed using the first clock frequency under a control of the first controller, while a data input to the second data register and a data output from the first data register are performed using the second clock frequency under a control of the second controller. This allows a data input to the first data register and a data output from the first data register to be separately performed, and allows a data input to the second data register and a data output from the second data register to be separately performed even if the first and second clock frequencies have no multiple frequency relation. Therefore, a bi-directional RAM having a simple structure can be achieved without increased production cost.

In a preferable form, the first controller causes the data input to the second data register to be transferred and copied to the first data register when it detects that the flag has been set in the second flag register, and the second controller causes the data input to the first data register to be transferred and copied to the second data register when it detects that the flag has been set in the first flag register.

Therefore, when data is input to the first data register, the data can be transferred and copied to the second data register, and can be then output from the second data register. When data is input to the second data register, the data can be transferred and copied to the first data register, and can be then output from the first data register. This allows data input/output to/from the first data register and to/from the second data register in a flexible manner.

In a preferable form, the first controller prohibits a data input from the first control device when the flag is set in the second flag register, and the second controller prohibits a data input from the second control device when the flag is set in the first flag register.

This prevents data input from the second control device from being written to the second data register if a data input from the second control device occurs while an output from the first data register is transferred and copied to the second data register. This also prevents data input from the first control device from being written to the first data register if a data input from the first control device occurs while an output from the second data register is transferred and copied to the first data register. Therefore, a bi-directional RAM having a high reliability can be achieved which prevents data from missing or being altered.

### BRIEF DESCRIPTION OF THE DRAWING

The sole FIGURE is a block diagram of a main portion of a bi-directional RAM according to an embodiment of the present invention.

### DESCRIPTION OF THE PREFERRED EMBODIMENT

An embodiment of the present invention is now described with reference to the drawing.

The FIGURE is a block diagram of a main portion of a bi-directional RAM 21 according to an embodiment of the present invention.

As shown in the FIGURE, the bi-directional RAM 21 includes a first controller 1, a first data register 2, a first flag register 3, a first address register 4, a second controller 5, a second data register 6, a second flag register 7, a second address register 8, a first switch 9, a second switch 10, a third switch 11, a fourth switch 12, a first data terminal (T_{DATA1}) 13, a first address terminal (T_{ADR1}) 14, a first control terminal (T_{CONT1}) 15, a first clock terminal (T_{CLK1}) 16, a second data terminal (T_{DATA2}) 17, a second address terminal (T_{ADR2}) 18, a second control terminal (T_{CONT2}) 19, and a second clock terminal (T_{CLK2}) 20.

A first control device, such as a personal computer, for data transfer using a first clock frequency is connected to the left part of the bi-directional RAM 21, and a second control device, such as a wireless local area network, for data transfer using a second clock frequency is connected to the right part of the bi-directional RAM 21, although the first and second control devices are not shown in the FIGURE. The first and second clock frequencies are different, and have no multiple frequency relation. As an example, the first clock frequency used in the first control device may be 33 MHz, and the second clock frequency used in the second control device may be 20 MHz or a multiple thereof, such as 40 MHz or 60 MHz.

As further shown in the FIGURE, the bi-directional RAM 21 is divided into two sections by a one-dot chain line extending longitudinally at the center portion thereof. The clock frequency changes at the one-dot chain line, and the left section with respect to the one-dot chain line which includes the first controller 1 mainly serves to control the first controller 1 using the first clock frequency. The right section with respect to the one-dot chain line which includes the second controller 5 mainly serves to control the second controller 5 using the second clock frequency.

The first controller 1, the first data register 2, the first flag register 3, the first address register 4, the second controller 5, the second data register 6, the second flag register 7, the second address register 8, the first switch 9, the second switch 10, the third switch 11, the fourth switch 12, the first data terminal 13, the first address terminal 14, the first control terminal 15, the second data terminal 17, the second address terminal 18, and the second control terminal 19 are internally connected with each other within the bi-directional RAM 21 in the manner shown in the FIGURE. Although connections of the first clock terminal 16 and the second clock terminal 20 are not shown in the FIGURE, the first clock terminal 16 has functions to receive the first clock frequency from the first control device (not shown) and to cause the control operation of the first controller 1 to be in synchronous with the received first clock frequency, and the second clock terminal 20 has functions to receive the second clock frequency from the second control device (not shown) and to cause the control operation of the second controller 5 to be in synchronous with the received second clock frequency.

The operation of the bi-directional RAM 21 according to the present embodiment is now described.

First, the operation to supply data Dl-from the first control device to the bi-directional RAM 21, and to write the data D₁ to the first data register 2 and the second data register 6 is described.

The data D₁ is supplied to the first data terminal 13, a write address signal S_{AD} for the first data register 2 is supplied to the first address terminal 14, and a write control signal S_{CT} is supplied to the first control terminal 15. The first controller 1 decodes the write control signal S_{CT} supplied through the first control terminal 15 to form a write enable signal S_{WE1} for the first data register 2, a write enable signal S_{WE2} for the first address register 4,- a switching control signal, and a flag bit B_{FG1}. The write enable signals S_{WE1} and S_{WE2} are supplied to the first data register 2 and the first address register 4, respectively. The switching control signal is applied to the first switch 9 and the second switch 10, to switch the movable contact of each of the first switch 9 and the second switch 10 to the upper fixed contact so that the write address signal S_{AD} supplied to the first address terminal 14 is supplied to the first data register 2 through the first switch 9 and the data D₁ supplied to the first data terminal 13 is supplied to the first data register 2 through the second switch 10. The flag bit B_{FG1} is supplied to the first flag register 3. The first data register 2 writes the supplied data D₁ to the address designated by the supplied write address signal S_{AD} in response to the supplied write enable signal S_{WE1}. The first address register 4 writes the supplied write address signal S_{AD} in response to the supplied write enable signal S_{WE2}. A flag is set in the first flag register 3 in response to the supplied flag bit B_{FG1}. The foregoing operation is controlled by the first controller 1 using the first clock frequency.

The second controller 5 always polls or monitors a flagging state of the first flag register 3, and reads the write address signal S_{AD} written to the first address register 4 when the second controller 5 detects that a flag has been set in the first flag register 3 or the flag bit B_{FG1} has changed to 1. In response to the write address signal S_{AD} read, the second controller 5 forms a read enable signal S_{RE} for the first data register 2, a write enable signal S_{WE3} for the second data register 6, a write enable signal S_{WE4} for the second address register 8, a switching control signal, and a flag bit B_{FG2}. The read enable signal S_{RE} is supplied to the first data register 2, and the write enable signals S_{WE3} and S_{WE4} are supplied to the second data register 6 and the second address register 8, respectively. The switching control signal is applied to the third switch 11 and the fourth switch 12 to switch the movable contact of each of the third switch 11 and the fourth switch 12 to the upper fixed contact so that the write address signal S_{AD} output from the second controller 5 is supplied to the second data register 6 through the third switch 11, thus allowing the data output end of the first data register 2 to be connected to the data input end of the second data register 6. The flag bit B_{FG2} is supplied to the second flag register 7. The first data register 2 reads the written data D₁ from the address designated by the supplied write address signal S_{AD} in response to the supplied read enable signal S_{RE}. The read data D₁ is then supplied to the second data register 6 through the fourth switch 12. The second data register 6 writes the supplied data D₁ to the address designated by the supplied write address signal S_{AD} in response to the supplied write enable signal S_{WE3}, so that the data D₁ is copied. The second controller 5 causes the flag bit B_{FG2} indicating that the data D₁ has been transferred and copied from the first data register 2 to the second data register 6 to be set in the second flag register 7. The foregoing operation is controlled by the second controller 5 using the second clock frequency.

Similarly to the second controller 5, the first controller 1 always polls or monitors a flagging state of the second flag register 7, and resets the flag bit B_{FG1} set in the first flag register 3 when the first controller 1 detects that a flag has been set in the second flag register 7 or the flag bit B_{FG2} has changed to 1. As a sufficient time for the first controller 1 to detect that the flag bit B_{FG2} has changed to 1 has elapsed after the flag has been set in the second flag register 7, the flag is automatically reset.

Then, the operation to supply data D₂ from the second control device to the bi-directional RAM 21, and to write the data D₂ to the second data register 6 and the first data register 2 is described.

The data D₂ is supplied to the second data terminal 17, a write address signal S_{AD} for the second data register 6 is supplied to the second address terminal 18, and a write control signal S_{CT} is supplied to the second control terminal 19. The second controller 5 decodes the write control signal S_{CT} supplied through the second control terminal 19 to form a write enable signal S_{WE3} for the second data register 6, a write enable signal S_{WE4} for the second address register 8, a switching control signal, and a flag bit B_{FG2}. The write enable signals S_{WE3} and S_{WE4} are supplied to the second data register 6 and the second address register 8, respectively. The switching control signal is applied to the third switch 11 and the fourth switch 12 to switch the movable contact of each of the third switch 11 and the fourth switch 12 to the lower fixed contact so that the write address S_{AD} supplied to the second address terminal 18 is supplied to the second data register 6 through the third switch 11 and the data D₂ supplied to the second data terminal 17 is supplied to the second data register 6 through the fourth switch 12. The flag bit B_{FG2} is supplied to the second flag register 7. The second data register 6 writes the supplied data D₂ to the address designated by the supplied write address signal S_{AD} in response to the supplied write enable signal S_{WE3}. The second address register 8 writes the supplied write address signal S_{AD} in response to the supplied write enable signal S_{WE4}. A flag is set in the second flag register 7 in response to the supplied flag bit B_{FG2}. The foregoing operation is controlled by the second controller 5 using the second clock frequency.

The first controller 1 always polls or monitors a flagging state of the second flag register 7, and reads the write address signal S_{AD} written to the second address register 8 when the first controller 1 detects that the flag bit B_{FG2} has changed to 1. In response to the write address signal S_{AD} read, the first controller 1 forms a read enable signal S_{RE} for the second data register 6, a write enable signal S_{WE1} for the first data register 2, a write enable signal S_{WE2} for the first address register 4, a switching control signal, and a flag bit B_{FG1}. The read enable signal S_{RE} is supplied to the second data register 6, and the write enable signals S_{WE1} and S_{WE2} are supplied to the first data register 2 and the first address register 4, respectively. The switching control signal is applied to the first switch 9 and the second switch 10 to switch the movable contact of each of the first switch 9 and the second switch 10 to the lower fixed contact so that the write address S_{AD} output from the first controller 1 is supplied to the first data register 2 through the first switch 9, thus allowing the data output end of the second data register 6 to be connected to the data input end of the first data register 2. The flag bit B_{FG1} is supplied to the first flag register 3. The second data register 6 reads the written data D₂ from the address designated by the supplied write address signal S_{AD} in response to the supplied read enable signal S_{RE}. The read data D₂ is then supplied to the first data register 2 through the second switch 10. The first data register 2 writes the supplied data D₂ to the address designated by the supplied write address signal S_{AD} in response to the supplied write enable signal S_{WE1}, so that the data D₂ is copied. The first address register 4 writes the supplied write address signal S_{AD} in response to the supplied write enable signal S_{WE2}, and a flag is set in the first flag register 3 in response to the supplied flag bit B_{FG1}. The foregoing operation is controlled by the first controller 1 using the first clock frequency.

The second controller 5 always polls or monitors a flagging state of the first flag register 3, and resets the flag bit B_{FG2} set in the second flag register 7 when the second controller 5 detects that the flag bit B_{FG1} has changed to 1. As a sufficient time for the second controller 5 to detect that the flag bit B_{FG1} has changed to 1 has elapsed after the flag has been set in the first flag register 3, the flag is automatically reset.

In the bi-directional RAM 21 according to the present embodiment, if a request to write the data D₁ is generated from the first control device or a request to write the data D₂ is generated from the second control device during a data transfer within the bi-directional RAM 21, the first controller 1 and the second controller 5 perform their internal data transfer by priority. At the time when the internal data transfer is completed, the data D₁ or D₂ from the first or second control device is written.

In the bi-directional RAM 21 according to the present embodiment, if the first controller 1 and the second controller 5 receive an instruction for internal data transfer at the same time, the internal data transfer by the first controller 1 is performed prior to the internal data transfer by the second controller 5. After the internal data transfer by the first controller 1 is completed, the internal data transfer by the second controller 5 is then performed.

According to the present invention, therefore, the first controller 1 controls a data input to the first data register 2 and a data output from the second data register 6 using the first clock frequency, while the second controller 5 controls a data input to the second data register 6 and a data output from the first data register 2 using the second clock frequency. This allows the data input to the first data register 2 and the data output from the first data register 2 to be separately performed, and allows the data input to the second data register 6 and the data output from the second data register 6 to be separately performed if the first clock frequency and the second clock frequency have no multiple relation.

What is claimed is:

1. A bi-directional RAM coupled between a first control device for data transfer using a first clock frequency and a second control device for data transfer using a second clock frequency having no multiple relation with the first clock frequency, said bi-directional RAM comprising: a first data register; a second data register; a first flag register; a second flag register; a first controller; and a second controller, wherein the first controller performs a data input to the first data register and a data output from the second data register using the first clock frequency, and sets a flag in the first flag register when data is input to the first data register; and the second controller performs a data input to the second data register and a data output from the first data register using the second clock frequency, and sets a flag in the second flag register when data is input to the second data register.

2. A bi-directional RAM according to claim 1, wherein the first controller causes the data input to the second data register to be transferred and copied to the first data register when it detects that the flag has been set in the second flag register; and the second controller causes the data input to the first data register to be transferred and copied to the second data register when it detects that the flag has been set in the first flag register.

3. A bi-directional RAM according to claim 1, wherein the first controller prohibits a data input from the first control device when the flag is set in the second flag register; and the second controller prohibits a data input from the second control device when the flag is set in the first flag register.

4. A bi-directional RAM according to claim 3, wherein the first controller is set to a standby mode or a reentrant mode for the data input from the-first control device when it prohibits the data input from the first control device; and the second controller is set to-a standby mode or a reentrant mode for the data input from the second control device when it prohibits the data input from the second control device.

5. A bi-directional RAM according to claim 1, wherein the first control device comprises a personal computer, and the second control device comprises a wireless local area network.
